(19) United States
(12) Patent Application Publication
(10) Pub. No.: US 2025/0356050 A1
(43) Pub. Date: Nov. 20, 2025

(54) SYSTEMS AND METHODS FOR CATEGORIZING PERSONAL INFORMATION INTO RELEVANT CATEGORIES CORRESPONDING TO SOCIAL ENGAGEMENT ARTIFICIAL INTELLIGENCE (AI) AGENTS IN A PRIVACY AND AD-SENSITIVE MANNER

(71) Applicant: Affle (India) Limited, India, Gurugram (IN)

(72) Inventors: Anuj Khanna SOHUM, Singapore (SG); Charles Yong Jien FOONG, Templestowe (AU); Madhusudana RAMAKRISHNA, Singapore (SG)

(73) Assignee: Affle (India) Limited, India, Gurugram (IN)

(21) Appl. No.: 19/209,270

(22) Filed: May 15, 2025

(30) Foreign Application Priority Data
May 15, 2024 (IN) IN202311077672

(51) Int. Cl. G06F 21/62

(52) U.S. Cl. CPC G06F 21/6245

(57) ABSTRACT

Systems and methods for categorizing personal information into relevant categories corresponding to social engagement artificial intelligence (AI) agents are disclosed. The system categorizes information into predefined segments, which encompass categories such as family, work, friends, sports, budget, and more. The system prioritizes data security by preventing unauthorized access to sensitive Personally Identifiable Information (PII) by restricting data sharing between incompatible categories. Furthermore, the system promotes dynamic decision-making through real-time queries to various intelligent communicative agents. The approach results in a personalized and context-aware user experience, tailoring interactions to individual needs, thereby enhancing the quality and efficiency of human-AI interactions.

### CROSS-REFERENCE TO RELATED APPLICATIONS

This patent application claims priority to Indian Patent Application No. IN 202311077672, filed May 15, 2024, entitled “SYSTEMS AND METHODS FOR CATEGORIZING PERSONAL INFORMATION INTO RELEVANT CATEGORIES CORRESPONDING TO SOCIAL ENGAGEMENT ARTIFICIAL INTELLIGENCE (AI) AGENTS IN A PRIVACY AND AD-SENSITIVE MANNER” and assigned to the assignee hereof. The disclosure of the prior application is considered part of and is incorporated by reference in this patent application.

### TECHNICAL FIELD

Embodiments of the present disclosure generally relate to artificial intelligence (AI) based systems and more particularly to systems and methods for categorizing personal information into relevant categories corresponding to social engagement artificial intelligence (AI) agents.

### BACKGROUND

In digital age, rapid advancement of artificial intelligence (AI) technologies may have transformed the way individuals interact with digital systems and devices. Personal AI assistants and social AI agents may have been integral components of daily lives, aiding in various tasks and activities. The AI systems have the potential to significantly enhance personal and social interactions by providing tailored assistance and facilitating dynamic decision-making. However, despite the remarkable progress in AI, the full integration of AI agents into personal and social lives remains a challenge. Users often face limitations in terms of privacy, data categorization, and the ability to seamlessly engage with different AI agents representing family, friends, co-workers, teammates, and the like. The limitations stem from the need to strike a balance between personalized assistance and data security.

One of the primary challenges in developing personal AI systems is maintaining user privacy while harnessing the power of AI. Users generate a vast amount of data, including personal information, preferences, and communication histories. The need to categorize and secure this information is essential to ensure that sensitive data does not fall into the wrong hands. For example, there is a growing concern regarding the inadvertent sharing of private health information with work-related AI agents. To prevent unauthorized access and potential data breaches, there is a pressing need for AI systems capable of categorizing and securing information according to their relevance and context. Further, as personal AI assistants become more versatile and multi-faceted, the ability to interact with multiple AI agents representing different facets of an individual's life becomes increasingly important. Users often may need to engage with AI agents that represent their family and friends to facilitate natural and dynamic interactions to make informed decisions. This requires a level of collaboration and integration among different AI agents that are currently lacking in many AI systems, and often fall short in ensuring privacy and providing personalized, real-time decision support.

Consequently, there is a need for improved systems and methods for categorizing personal information into relevant categories corresponding to social engagement artificial intelligence (AI) agents.

### OBJECTS OF THE INVENTION

Some of the objects of the present disclosure, which at least one embodiment herein satisfy, are listed herein below.

It is an object of the present subject matter to overcome the afore mentioned and other drawbacks existing in the prior art systems and methods.

It is a significant object of the present subject matter to design and develop a system and an associated method that is capable of automatically categorizing as received information into different fields related to specific intelligent communicative agents.

It is another principal object of the present subject matter to design and develop the system such that the system facilitates compartmentalized processing of information by intelligent communicative agents to prevent overlapping actions.

It is another object of the present subject matter to design and develop the system where the system facilitates prioritization between multiple outputs as received from several intelligent communicative agents.

It is another object of the present subject matter to design and develop the system where the system ensures response quality, personalization and evolution of communicative agent's behavior over time.

It is yet another object of the present subject matter to design and develop the system such that the system generates decision in a user consent driven manner.

It is even another object of the present subject matter to design and develop the system such that the system is simple to implement.

These and other objects and advantages of the present subject matter, will be apparent to a person skilled in the art after consideration of the following detailed description, taken into consideration with accompanied drawings in which preferred embodiments of the present subject matter are illustrated.

### SUMMARY OF THE INVENTION

This summary is provided to introduce concepts related to a system for categorizing personal information by integrating one or more intelligent communicative agents. The concepts are further described below in the detailed description. This summary is not intended to identify key features or essential features of the claimed subject matter, nor is it intended to be used to limit the scope of the claimed subject matter.

According to an embodiment, there is provided the system for categorizing personal information by integrating one or more intelligent communicative agents.

In an aspect, the system comprises of at least one primary intelligent communicative agent, a plurality of secondary intelligent communicative agents, where each of the plurality of secondary intelligent communicative agents are associated with scope of a predefined field, a memory unit, where the memory unit is configured to store information related to the at least one primary intelligent communicative agent and the plurality of secondary intelligent communicative agents, one or more processors, where one or more processors are configured to identify nature of request and relevant fields to be addressed by at least one primary intelligent communicative agent, determine normalized threshold by at least one primary intelligent communicative agent to ensure further processing, trigger communicative interaction between at least one primary intelligent communicative agent and the plurality of secondary intelligent communicative agents, and/or between each of the plurality of secondary intelligent communicative agents, generate a real time information based on the communication between the at least one primary agent and the plurality of secondary intelligent communicative agents, one or more communication networks, where the one or more communication networks are configured to receive as generated real time information from the at least one primary intelligent communicative agent and transmit the real-time information to one or more user devices communicatively coupled to the system and a database configured to receive information from the system by means of the one or more communication networks and store the information for future purposes.

In an aspect, the at least one primary communicative agent selectively triggers inter-communication between one or more secondary intelligent communicative agents of the plurality of secondary intelligent communicative agents by identifying the required field upon receipt of request.

In an aspect, the at least one primary communicative agent delegates task to one or more of the plurality of secondary intelligent communicative agents upon identifying the required field.

In an aspect, the one or more processors comprises of an access control device configured to authenticate access to each of the plurality of secondary intelligent communicative agents such that each of the plurality of secondary intelligent communicative agents operate within the predefined field.

In an aspect, the at least one primary intelligent communicative agent co-ordinates with each of the plurality of secondary intelligent communicative agents by principle of local inter-process communication.

In an aspect, inter-communication between the plurality of secondary intelligent communicative agents is performed following a two-way communication protocol implementing neural networks.

In an aspect, the system is configured to allow independent inter-communication between each of the plurality of secondary intelligent communicative agents.

In an aspect, the one or more processors are configured to prompt for feedback on action undertaken by at least one primary intelligent communicative agent, store the feedback received into a storage unit, readapt the at least one primary intelligent communicative agent and the plurality of secondary intelligent communicative agents based on the feedback received.

In an aspect, the database may include but is not limited to personal data, health data, lifestyle data, any other data, and combinations thereof.

In an aspect, the plurality of secondary intelligent communicative agents may include but is not limited to family agent, work agent, friends agent, budget agent, sports agent and a plurality of other agents.

In an aspect, the information processed and transmitted by the plurality of other agents may include but is not limited to health, travel, entertainment and like fields.

In an aspect, there is provided a method for categorizing personal information by integrating one or more intelligent communicative agents. In an aspect, the method comprises receiving request by at least one primary intelligent communicative agent, identifying nature of request by at least one primary intelligent communicative agent, determining normalized threshold by at least one primary intelligent communicative agent to ensure further processing, triggering communication with one or more of the plurality of secondary intelligent communicative agents based on nature of request received by the at least one primary intelligent communicative agent, delegating specific tasks by at least one primary intelligent communicative agent to the one or more of the plurality of secondary intelligent communicative agents based on nature of request via the one or more processors, generating real time information based on the communication between the at least one primary intelligent communicative agent and the plurality of secondary intelligent communicative agents, transmitting as generated real time information by the at least one primary agent to one or more communication networks, transmitting the generated real-time information to one or more user devices by the one or more communication networks upon receipt, prompting for feedback by the one or more processors on action undertaken by at least one primary intelligent communicative agent storing the feedback received into a storage unit, readapting the at least one primary intelligent communicative agent and the plurality of secondary intelligent communicative agents based on the feedback received.

In an aspect, the method includes selectively triggering inter-communication between one or more secondary intelligent communicative agents of the plurality of secondary intelligent communicative agents by identifying the required field.

In an aspect, the method includes authenticating access to each of the plurality of secondary intelligent communicative agents such that each of the plurality of secondary intelligent communicative agents operate within the predefined field.

In an aspect, the method includes performing inter-communication between the plurality of secondary intelligent communicative agents by means of a two-way communication protocol implemented using neural networks.

In an aspect, the method includes communication between at least one primary intelligent communicative agent and each of the plurality of secondary intelligent communicative agents by principle of local inter-process communication.

To further understand the characteristics and technical contents of the present subject matter, a description relating thereto will be made with reference to the accompanying drawings. However, the drawings are illustrative only but not used to limit the scope of the present subject matter.

Various objects, features, aspects, and advantages of the inventive subject matter will become more apparent from the following detailed description of preferred embodiments, along with the accompanying drawing figures in which numerals represent like components.

### BRIEF DESCRIPTION OF THE DRAWINGS

It is to be noted, however, that the appended drawings illustrate only typical embodiments of the present subject matter and are therefore not to be considered for limiting its scope, for the invention may admit to other equally effective embodiments. A detailed description is given with reference to the accompanying figures. In the figures, a reference number identifies the figure in which the reference number first appears. The same numbers are used throughout the figures to refer like features and components. Some embodiments of system or methods or structure in accordance with embodiments of the present subject matter are now described, by way of example, and with reference to the accompanying figures, in which

FIG. 1 illustrates an exemplary block diagram representation of a network architecture implementing a system for categorizing personal information into relevant categories corresponding to social engagement artificial intelligence (AI) agents in accordance with an embodiment of the present disclosure;

FIG. 2 illustrates an exemplary block diagram representation of a computer implemented system, such as those shown in FIG. 1, capable of categorizing personal information into relevant categories corresponding to social engagement artificial intelligence (AI) agents, in accordance with an exemplary embodiment of the present disclosure;

FIG. 3 illustrates an exemplary flow diagram representation of interaction of personal/social human engagement agent including a plurality of artificial intelligence (AI) agents, in accordance with an embodiment of the present disclosure; and

FIG. 4 depicts an example method of operation of the system in accordance with an exemplary embodiment of the present disclosure.

The figures depict embodiments of the present subject matter for the purposes of illustration only. A person skilled in art will easily recognize from the following description that alternative embodiments of the structures and methods illustrated herein may be employed without departing from the principles of the disclosure described herein.

Further, those skilled in art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or subsystems or elements or structures or components preceded by “comprises . . . a” does not, without more constraints, preclude the existence of other devices, subsystems, additional sub-modules. The appearance of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

Embodiments of the present disclosure provide systems and methods for categorizing personal information into relevant categories corresponding to social engagement artificial intelligence (AI) agents.

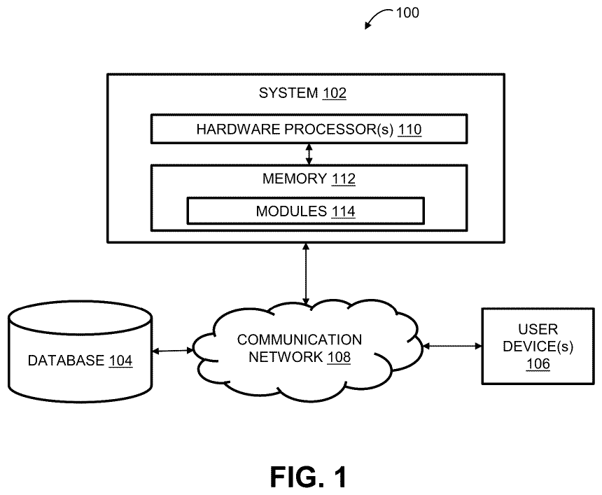

Referring now to the drawings, and more particularly to FIG. 1 through FIG. 4, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture (100) implementing a system (102) for categorizing personal information into relevant categories corresponding to social engagement artificial intelligence (AI) agents, in accordance with an embodiment of the present disclosure.

In an aspect, as can be witnessed from FIG. 1, the network architecture (100) may include a system (102), a database (104), and one or more user devices (106).

The one or more user devices (106) may be associated with one or more users and communicatively coupled to the system (102) via one or more communication networks (108).

In an exemplary embodiment of the present disclosure, the user devices (106) may include a laptop computer, desktop computer, tablet computer, smartphone, wearable device, a digital camera, and the like. Further, the one or more communication network (108) may be a wired network or a wireless network.

In an aspect, the system (102) may be at least one of, but not limited to, a central server, a cloud server, a remote server, an electronic device, a portable device, and the like. Further, the system (102) may be communicatively coupled to the database (104), via the one or communication network (108).

In an aspect, the database (104) may include, but is not limited to, personal data, health data, lifestyle data, any other data, and combinations thereof. The database (104) may be any kind of database/repositories such as, but are not limited to, relational database, dedicated database, dynamic database, monetized database, scalable database, cloud database, distributed database, any other database, and combination thereof.

Further, the user device (106) may be associated with, but not limited to, a user, an individual, an administrator, a vendor, a technician, a worker, a specialist, a healthcare worker, an instructor, a supervisor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like.

The one or more user devices (106) may be used to provide input and/or receive output to/from the system (102), and/or to the database (104), respectively. The one or more user devices (106) may present to the user one or more user interfaces for the user to interact with the system (102) and/or to the database (104) for categorizing personal information into relevant categories need. The one or more user devices (106) may be at least one of, an electrical, an electronic, an electromechanical, and a computing device. The one or more user device (106) may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Further, the system (102) may be implemented by way of a single device or a combination of multiple devices that may be operatively connected or networked together. The system (102) may be implemented in hardware or a suitable combination of hardware and software.

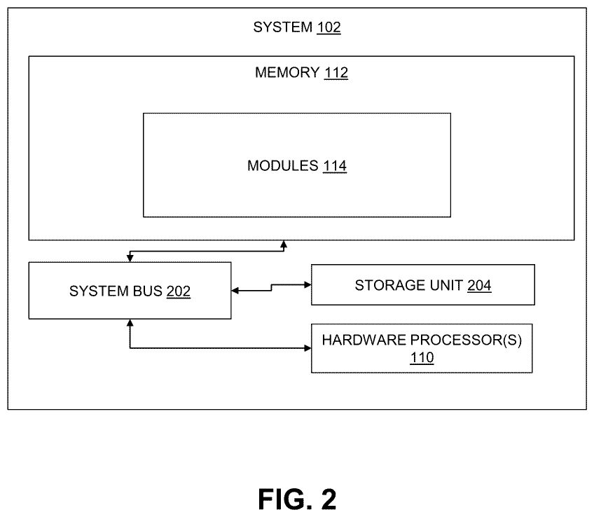

FIG. 2 illustrates an exemplary block diagram representation of a computer implemented system, such as those shown in FIG. 1, capable of categorizing personal information into relevant categories corresponding to social engagement artificial intelligence (AI) agents, in accordance with an embodiment of the present disclosure.

In an aspect, the system (102) may comprise of at least one primary intelligent communicative agent (302) and a plurality of secondary intelligent communicative agents (304-1, 304-2, . . . , 304-N). Herein, each of the plurality of secondary intelligent communicative agents (304-1, 304-2, . . . , 304-N) may be associated with scope of a predefined field.

In an aspect, the system (102) may comprise of a memory unit (112), where the memory (112) may include a plurality of modules (114) and is configured to store information related to at least one primary intelligent communicative agent (302) and the plurality of secondary intelligent communicative agents (304-1, 304-2, . . . , 304-N).

In an aspect, the system (102) may further comprise of one or more processors (110), with the one or more processors (110) being configured to identify nature of request and relevant fields to be addressed by at least one primary intelligent communicative agent (302), determine normalized threshold by the at least one primary intelligent communicative agent (302) to ensure whether to proceed or involve additional queries, trigger communication interaction, which may be between at least one primary intelligent communicative agent (302) and the plurality of secondary intelligent communicative agents (304-1, 304-2, . . . , 304-N) or among the plurality of secondary intelligent communicative agents (304-1, 304-2, . . . , 304-N). Herein, the one or more processors (110) selectively triggers the communication between the at-least one primary intelligent communicative agent (302) and the secondary intelligent communicative agents (304-1, 304-2, . . . , 304-N) or may be inter-communication between the plurality of secondary intelligent communicative agents (304-1, 304-2, . . . , 304-N) depending on the nature of request received by the at least one primary intelligent communicative agent (302). The field of request is identified by the at least one primary intelligent communicative agent (302), which is followed by delegating required task to one or more of the plurality of secondary intelligent communicative agents (304-1, 304-2, . . . , 304-N).

It may also be mentioned in this context that one or more processors (110) are equipped with an access control device configured to authenticate access each of the plurality of secondary intelligent communicative agents (304-1, 304-2, . . . , 304-N), such that each of these agents operate within the predefined field.

In an aspect, further, the one or more processors (110) are configured to generate real time information based on the above-mentioned communications.

In an aspect, the one or more communication networks (108) are configured to receive as generated real time information from the at least one primary intelligent communicative agent (302) and transmit the same to one or more user devices (106) communicatively coupled to the system (102).

Further, in an aspect, the database (104) is configured to receive information from the system (102) by means of the one or more communication networks (108), so as to store information for future purposes.

In an aspect, herein, at least one primary intelligent communicative agent (302) co-ordinates with each of the plurality of secondary intelligent communicative agents (304-1, 304-2, . . . , 304-N) by following principle of local inter-process communication.

In an aspect, the inter-communication between the plurality of secondary intelligent communicative agents (304-1, 304-2, . . . , 304-N) may be performed following a two-way communication protocol implementing neural networks.

In an aspect, moreover, the system (102) is also configured to allow independent inter-communication between each of the plurality of secondary intelligent communicative agents (304-1, 304-2, . . . , 304-N) by identifying the nature of request and suitable delegation involved.

In an aspect, the one or more processors (110) are configured to prompt for feedback on action undertaken by at least one primary intelligent communicative agent, store the feedback received into a storage unit (204), readapt the at least one primary intelligent communicative agent (302) and the plurality of secondary intelligent communicative agents (304-1, 304-2, . . . , 304-N) based on the feedback received.

In an aspect, the one or more processors (110) are configured to execute machine-readable program instructions for categorizing personal information into relevant categories corresponding to the intelligent communicative agents. Execution of the machine-readable program instructions by the one or more processors (110) may enable the proposed system (102) to categorizing personal information into relevant categories corresponding to the plurality of secondary intelligent communicative agents (304-1, 304-2, . . . , 304-N). The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications as well as with the one or more processors (110).

The one or more hardware processors (110) may include, for example, microprocessors, microcomputers, microcontrollers, digital signal processors, central processing units, state machines, logic circuits, and/or any devices that manipulate data or signals based on operational instructions. Among other capabilities, one or more processors (110) may fetch and execute computer-readable instructions in the memory (112) operationally coupled with the system (102) for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, sensors, any other devices, and combination thereof. The person skilled in art should not be limiting the components/subsystems shown in FIG. 1. Although FIG. 1 illustrates the system (102), and the user device (106) connected to the database (104), one skilled in the art can envision that the system (102), and the user device (106) can be connected to several user devices located at various locations and several databases via the one or more communication network (108).

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in art will recognize that, for simplicity and clarity, the full structure and operation of the one or more processors (110) suitable for use with the present disclosure are not being depicted or described herein. Instead, only so much of the system (102) as is unique to the present disclosure or necessary for an understanding of the present disclosure is depicted and described. The remainder of the construction and operation of the system (102) may conform to any of the various current implementations and practices that were known in art.

In an aspect, the plurality of secondary intelligent communicative agents (304-1, 304-2, 304-3, . . . , 304-N) may include but is not limited to family agent (304-1), work agent (304-2), friends agent (304-3), budget agent (304-4), sports agent (304-5) and a plurality of other agents (304-N). The plurality of other agents (304-N) may include but is not limited to health, travel, entertainment and like fields.

In an exemplary embodiment, as already mentioned, the system (102) may control access and data segregation to safeguard confidential information, by limiting the sharing of data across incompatible categories.

In an aspect, as can be evidenced from FIG. 2, the system (102) may comprise a storage unit (204). The one or more hardware processors (110), the memory (112), and the storage unit (204) are communicatively coupled through a system bus (202) or any similar mechanism. The memory (112), as mentioned before, comprises a plurality of modules 114 in the form of programmable instructions executable by the one or more hardware processors (110).

The one or more hardware processors (110), as used herein, means any type of computational circuit, such as, but not limited to, a microprocessor unit, microcontroller, complex instruction set computing exceptionally long processor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors (110) may also include embedded controllers, such as generic or programmable logic devices or arrays, application-specific integrated circuits, single-chip computers, and the like.

The memory (112) may be a non-transitory volatile memory and a non-volatile memory. The memory (112) may be coupled to communicate with the one or more hardware processors (110), such as being a computer-readable storage medium. The one or more hardware processors (110) may execute machine-readable instructions and/or source code stored in the memory (112). A variety of machine-readable instructions may be stored in and accessed from the memory (112). The memory (112) may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like.

In the present embodiment, the memory (112) includes the plurality of modules (114) stored in the form of machine-readable instructions on any of the above-mentioned storage media and may be in communication with and executed by the one or more hardware processors (110).

The storage unit (204) may be a cloud storage or a repository such as those shown in FIG. 1. The storage unit (204) may store, but is not limited to, telemetry signals, alerts, operations, health status, any other data, and combinations thereof. The storage unit (204) may be any kind of database/repositories such as, but are not limited to, relational database, dedicated database, dynamic database, monetized database, scalable database, cloud database, distributed database, any other database, and combination thereof.

In an exemplary embodiment, the plurality of modules (114) may categorize information into predefined categories. The predefined categories include, but are not limited to, family, work, friends, sports, budget, and the like. The plurality of modules (114) may securely handle and protect sensitive data, thereby preventing unauthorized access to sensitive Personally Identifiable Information (PII) by agents in incompatible categories. An example of this is to make an advertisement/recommendation to go for a sporting activity based on preferences and budget.

In an exemplary embodiment, the plurality of modules (114) may control access and data segregation by means of the one or more processors (110) to safeguard confidential information, by limiting the sharing of data across incompatible categories.

In an exemplary embodiment, the plurality of modules (114) may also allow dynamic decision-making processes by enabling real-time querying of different AI agents (not shown). For example, querying a user's family agent (primary agent) and/or friends' agent to determine user preferences. Subsequently enabling similar queries to external agents, such as Person A's agent (primary intelligent communicative agent), to facilitate collaborative decision-making, ensuring the selection of a suitable restaurant or alternative decision based on shared preferences. For example, if Person A is represented by a primary intelligent communicative agent, the primary agent may conduct internal queries and exchange information with the plurality of secondary intelligent communicative agents, enabling the seamless collaborative decision-making process and information sharing. The system (102) may provide personalized and context-aware user experience by tailoring interactions to the individual preferences and needs of the user, thereby enhancing the quality and efficiency of interactions between the at least one primary intelligent communicative agent (302) and the plurality of secondary intelligent communicative agents (304-1, 304-2, . . . , 304-N).

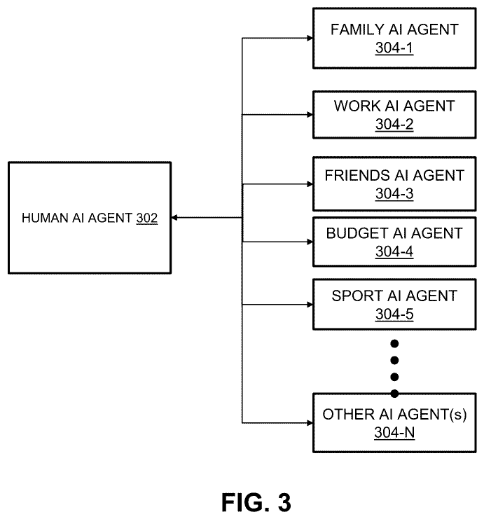

FIG. 3 illustrates an exemplary flow diagram representation of interaction of the at least one primary intelligent communicative agent (302) and the plurality of secondary intelligent communicative agents (304-1, 304-2, . . . , 304-N).

For example, a user via the user device (106) may interact with the at least one primary agent (302), which may be a central point of contact for various tasks, questions, and requests. For example, the family agent (304-1) may represent the user's family-related information and preferences. The family agent (304-1) may assist with tasks related to family communication and activities. Further, the work agent (304-2) may handle work-related tasks, such as scheduling work-related meetings, tasks, communication with colleagues, and the like. Further, the friends agent (304-3) may be dedicated to managing interactions and preferences related to the user's friends, helping plan social events and facilitating communication with friends. Furthermore, the budget agent (304-4) may focus on financial aspects, helping the user manage their budget, expenses, financial planning, and the like. Additionally, the sports agent (304-5) may be responsible for keeping the user informed about sports events, scores, and assisting with planning, following sports-related activities, and the like. Further, the other agents (304-N) may represent additional specialized areas such as health, entertainment, travel, or any domain relevant to the user's needs and preferences.

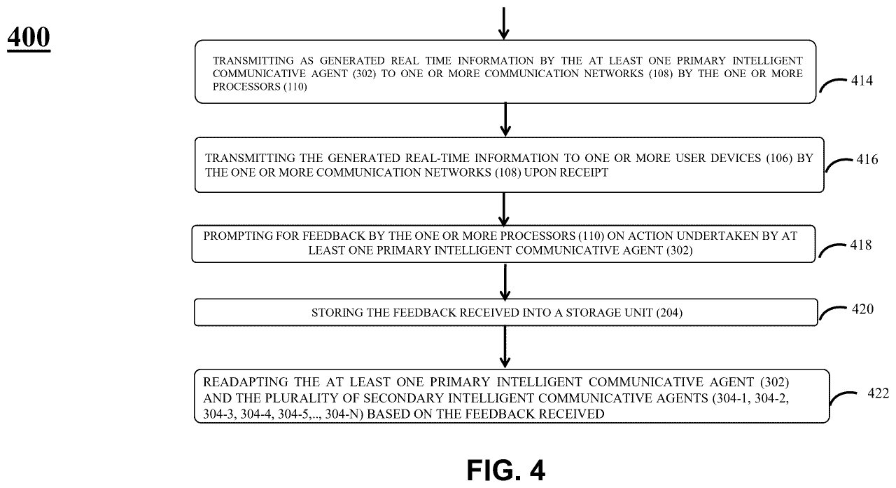

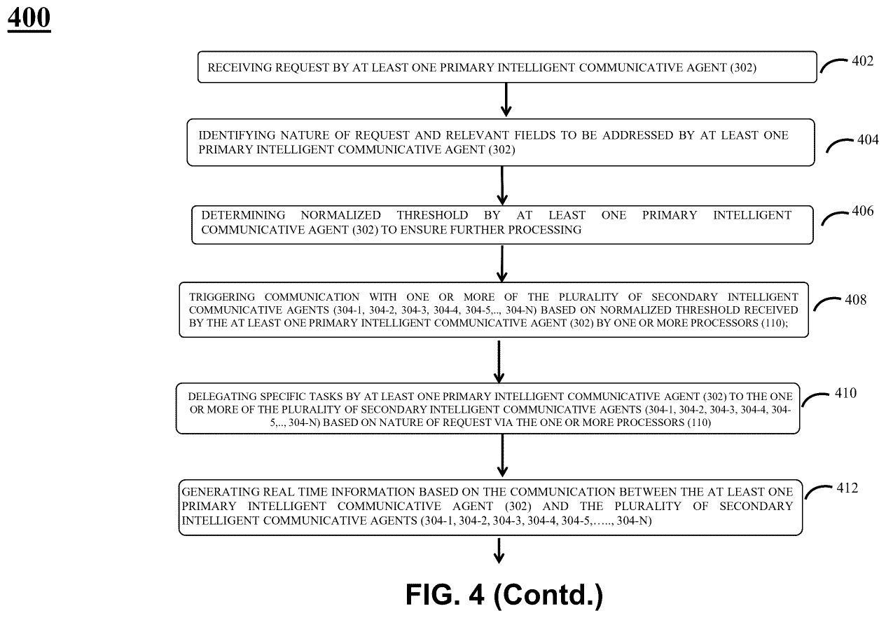

FIG. 4 depicts an example method of operation of the system in accordance with an exemplary embodiment of the present disclosure. The order in which the method (400) is described is not intended to be construed as a limitation, and any number of the described method blocks may be combined in any order to implement the method (400), or an alternative method.

At block (402), the method (400) includes receiving requests by at least one primary intelligent communicative agent (302).

At block (404), the method (400) includes identifying the nature of request by at least one primary intelligent communicative agent (302).

At block (406), the method (400) includes determining normalized threshold by at least one primary intelligent communicative agent (302) to ensure further processing. The threshold is used to obtain confidence level required for response by means of neural networks and further determine whether to provide information from available intelligent communicative agents or request more data or involve human intervention.

At block (408), the method (400) includes triggering communication with one or more of the plurality of secondary intelligent communicative agents (304-1, 304-2, 304-3, 304-4, 304-5, . . . , 304-N) based on normalized threshold received by at least one primary intelligent communicative agent (302). This method is pursued by the one or more processors (110). Herein, the atleast one primary intelligent communicative agent (302) based on the determined normalized threshold decides whether to proceed with agent communication. In case the threshold is met, the method includes initiating communication between the at least one primary intelligent communicative agent (302) and the plurality of secondary intelligent communicative agents (304-1, 304-2, 304-3, 304-4, 304-5, . . . , 304-N) that are relevant to the request or query being made.

At block (410), the method (400) includes delegating task by at least one primary intelligent communicative agent (302) to the one or more of the plurality of secondary intelligent communicative agents (304-1, 304-2, 304-3, 304-4, 304-5, . . . , 304-N) based on nature of request.

At block (412), the method (400) includes generating real time information based on the communication between the at least one primary agent (302) and the plurality of secondary intelligent communicative agents (304-1, 304-2, 304-3, 304-4, 304-5, . . . , 304-N). Herein, the plurality of secondary intelligent communicative agents (304-1, 304-2, 304-3, 304-4, 304-5, . . . , 304-N) are configured to process queries/requests and provide information or perform actions according to their predefined fields. The at least one primary agent (302) collects and integrates responses obtained from the plurality of secondary intelligent communicative agents (304-1, 304-2, 304-3, 304-4, 304-5, . . . , 304-N).

At block (414), the method (400) includes transmitting as generated real time information by at least one primary intelligent communicative agent (302) to one or more communication networks (108) by the one or more processors (110).

At block (416), the method (400) includes transmitting the generated real-time information to one or more user devices (106) by the one or more communication networks (108) upon receipt.

At block (418), the method (400) includes prompting for feedback by the one or more processors (110) on action undertaken by at least one primary intelligent communicative agent (302). Herein, the feedback may include star rating, thumbs up/down or qualitative inputs for example, comments.

At block (420), the method (400) includes storing the feedback received into a storage unit (204).

At block (422), the method (400) includes readapting the at least one primary intelligent communicative agent (302) and the plurality of secondary intelligent communicative agents (304-1, 304-2, 304-3, 304-4, 304-5, . . . , 304-n) based on the feedback received. Herein, the method (400) may include continuous learning followed by refining responses based on feedback received.

That said, the stored feedback data is used to train and adjust the features of the at least one primary intelligent communicative agent (302) and the plurality of secondary intelligent communicative agents (304-1, 304-2, 304-3, 304-4, 304-5, . . . , 304-N).

In an aspect, the method (400) includes selectively triggering inter-communication between one or more secondary intelligent communicative agents of the plurality of secondary intelligent communicative agents (304-1, 304-2, 304-3, 304-4, 304-5, . . . , 304-N) by identifying the required field.

In an aspect, the method (400) includes authenticating access to each of the plurality of secondary intelligent communicative agents (304-1, 304-2, 304-3, 304-4, 304-5, . . . , 304-N) such that each of the plurality of secondary intelligent communicative agents (304-1, 304-2, 304-3, 304-4, 304-5, . . . , 304-N) operate within the predefined field.

In an aspect, the method (400) includes communication between at least one primary intelligent communicative agent (302) and each of the plurality of secondary intelligent communicative agents (304-1, 304-2, 304-3, 304-4, 304-5, . . . , 304-N) by principle of local inter-process communication.

In an aspect, the method (400) includes iterative training of the at least one primary intelligent communicative agent (302) and the plurality of secondary intelligent communicative agents (304-1, 304-2, 304-3, 304-4, 304-5, . . . , 304-N) followed by adjusting normalized threshold in order to readapt the at least one primary intelligent communicative agent (302) and the plurality of secondary intelligent communicative agents (304-1, 304-2, 304-3, 304-4, 304-5, . . . , 304-N).

In an aspect, the method (400) includes monitoring of response time, modifications to suggestions as provided by the at least one primary intelligent communicative agent (302) and the plurality of secondary intelligent communicative agents (304-1, 304-2, 304-3, 304-4, 304-5, . . . , 304-N) to provide an implicit feedback.

### Exemplary Interaction Process Between the Intelligent Communicative Agents

Consider a scenario in which the user may communicate a request or question to the primary intelligent communicating agent (302). The primary agent (302) may process the user's request and decide which category of agents (304) are needed to fulfil the request. The primary agent (302) may interact with the relevant category of the plurality of secondary intelligent communicating agents (304), querying them for information or actions based on the user's request. The category of the plurality of secondary intelligent communicating agents (304) provides the requested information or carry out tasks as per the trained information.

Additionally, the primary agent (302) may collate and present the information to the user in a cohesive and understandable manner. The primary agent (302) may serve as an intelligent intermediary that streamlines and orchestrates interactions with various AI agents such as the category of the plurality of secondary intelligent communicative agents (304-1, 304-2, . . . , 304-N), allowing the user to access a wide range of capabilities and expertise without needing to communicate separately with each specialized agent, and maintaining.

In an exemplary embodiment, the privacy of information being shared with other agents may be a vital part of the engagement, where the system has opt-in, opt-out and the ability to right-to-forget information between agents and time duration that data must be kept. For example, if an agent accidentally shares personal information from a family agent to a co-worker agent, the system (102) should be able to issue a right to forget to the agent.

In an embodiment, the agent's data-sharing information may be done locally, stored securely on the server and or through a service or another agent.

In an exemplary embodiment, responses from agents may be in the form of a list of actions, which then the agent can use to infer the correct response. The formulation of these responses may be done via also incentivized mechanisms. For example, incentive recommendations are that a product/brand/service could offer discounts or payments to recommend a product/brand/service. The number of incentivized recommendations may be controlled by the user, including any personalized information, categories or interests.

In an exemplary embodiment, the agents may also be in the form of web-plugins/extensions, application on the users mobile/laptop/AR devices/VR devices/digital or smart glasses. In digital environments, these can be code-running applications, independent objects and/or scripts attached to an avatar such as through a scripted HUD.

In an exemplary embodiment, the manifestation of the interactions should be chats text, voice, video, in world avatar consumed through AR/VR. As an agent, there could be several manifestations as a cartoon avatar, semi-format avatar to realistic view.

### Exemplary Scenario 1:

The system (102) may possess the capability to intelligently categorize relevant information into specific segments, such as, but not limited to, family, work, friends, and the like. This ensures that confidential information, such as, but not limited to, private health information, are not shared with work-related agents to prevent the inadvertent disclosure of sensitive Personally Identifiable Information (PII) to co-workers. The system (102) may facilitate real-time querying of various agents (304-1, 304-2, . . . , 304-N) to arrive at well-informed decisions.

For instance, in the scenario where scheduling a lunch meeting with Person ‘A’ is desired, the system (102) allows the primary intelligent communicative agent (302) to initiate queries to the Person ‘A's’ family agent (304-1) and/or the friends agent (304-3) to determine Person ‘A's’ meal preferences. Subsequently, the same query is directed to Person A. In cases where Person A is represented by the primary intelligent communicative agent (302), the primary intelligent communicative agent (302) may engage in a similar internal query and relay the information to enable the selection of a suitable restaurant. The system (102) may then put an advertisement/recommendation on lunch locations based upon the above preferences.

### Exemplary Scenario 2:

In another instance, consider an interaction between user and the primary intelligent communicative agent (302). The user may query the primary intelligent communicative agent (302) as “I'd like to schedule a lunch meeting with my friend, person A.”. The primary intelligent communicative agent (302) may reply “of course, I can assist with that. To ensure it's a great experience, let me first check your meal preferences”. The primary intelligent communicative agent (302) may query family agent (304-1) and/or the friends agent (304-3) for the information. The family agent (304-1) may reply “hello, how can I assist you?”. The primary intelligent communicative agent (302) may query as “I need to know the user's meal preferences for a lunch meeting with person A, can you provide that information?”.

Further, the family agent (304-1) may reply “certainly, based on our past interactions, the user prefers vegetarian options and enjoys Italian cuisine.”. Further, the the primary intelligent communicative agent (302) may reply to the family agent (304-1) as “thank you. Now I'll make the same query to the friends agent (304-3).” The friends agent (304-3) may reply as “hello, how can I help you?”. Then the primary intelligent communicative agent (302) may reply to the friends agent (304-3) as “I need to know the user's meal preferences for a lunch meeting with person A. can you provide that information?”. Then the friends agent (304-3) may reply as “certainly, based on our past interactions, the user enjoys seafood and has a preference for sushi.” Further, the primary intelligent communicative agent (302) may reply as “thank you for the information. now, I'll query the primary intelligent communicative agent (302) agent of the friend to inquire about their meal preferences.

The primary intelligent communicative agent (302) of the friend may reply as “hello, how can I assist you with the lunch meeting?”, then the primary intelligent communicative agent (302) may reply “I'd like to ensure the user and person A have a great lunch experience. Can you share person a's meal preferences?”. Then the primary intelligent communicative agent (302) may reply as “certainly, person a enjoys Mexican cuisine, specifically tacos and burritos.” Additionally, the primary intelligent communicative agent (302) may reply as “thank you for the information, based on the preferences, it seems both the user and person A have a diverse range of options they enjoy. I'll find a restaurant that offers Italian, seafood, and Mexican cuisine. This way, they can have a variety to choose from.” The person A's primary intelligent communicative agent (302) may reply to the primary intelligent communicative agent (302) as “that sounds like a great idea. please go ahead and make the reservation at a restaurant that offers these options.”

### Technical Advantages:

All in all, the present invention has the following advantages:
i) automatically categorizes as received information into different field specific intelligent communicative agents
ii) facilitates compartmentalized processing of information by intelligent communicative agents to prevent overlapping actions
iii) facilitates prioritization between multiple outputs as received from several intelligent communicative agents.
iv) ensures s response quality, personalization and evolution of communicative agent's behavior over time.
v) generates decision in a user consent driven manner
vi) simple to implement

In an aspect, the present invention also discloses a non-transitory machine-readable medium including data, which when used by the system (102) for categorizing personal information by integrating one or more intelligent communicative agents, causes the system (102) to perform instructions that cause the system (102) to perform operations comprising receiving, by at least one primary intelligent communicative agent (302), a request from a user for performing a task by the at least one primary intelligent communicative agent (302), identifying, by at least one primary intelligent communicative agent (302), at least one category-specific AI agent from the plurality of secondary intelligent communicative agents (304-1, 304-2, . . . , 304-N) based on the request, extracting, by the at least one primary intelligent communicative agent (302), relevant information related to the request from each of at least one category-specific AI agent of the plurality of secondary intelligent communicative agents (304-1, 304-2, . . . , 304-N) based on the request, triggering, by the at least one primary intelligent communicative agent (302), at least one agent from the plurality of secondary intelligent communicative agents (304-1, 304-2, . . . , 304-N) based on the request, wherein at least one agent from the plurality of secondary intelligent communicative agents (304-1, 304-2, . . . , 304-N) provides auxiliary information related to the request, determining, by the at least one primary intelligent communicative agent (302), a normalized threshold score based on one or more parameters of the plurality of secondary intelligent communicative agents (304-1, 304-2, . . . , 304-N), generating, by the at least one primary intelligent communicative agent (302), at least one recommendation from the relevant information and the auxiliary information based on the normalized score and providing, by the at least one primary intelligent communicative agent (302), at least one recommendation to the user in response to the request.

For the sake of brevity, the construction and operational features of the system (102) which are explained in detail above are not explained in detail herein. Particularly, computing machines such as but not limited to internal/external server clusters, quantum computers, desktops, laptops, smartphones, tablets, and wearables may be used to execute system (102) or may include the structure of the hardware platform. As illustrated, the hardware platform may include additional components not shown, and some of the components described may be removed and/or modified. For example, a computer system with multiple GPUs may be located on external-cloud platforms including Amazon Web Services® (AWS), internal corporate cloud computing clusters, or organizational computing resources.

The hardware platform may be a computer system such as the system (102) that may be used with the embodiments described herein. The computer system may represent a computational platform that includes components that may be in a server or another computer system. The computer system may be executed by the processor (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor that executes software instructions or code stored on a non-transitory computer-readable storage medium to perform methods of the present disclosure. The software code includes, for example, instructions to gather data and analyze the data as the plurality of modules (114).

The instructions on the computer-readable storage medium are read and stored the instructions in storage or random-access memory (RAM). The storage may provide a space for keeping static data where at least some instructions could be stored for later execution. The stored instructions may be further compiled to generate other representations of the instructions and dynamically stored in the RAM such as RAM. The processor may read instructions from the RAM and perform actions as instructed.

The computer system may further include the output device to provide at least some of the results of the execution as output including, but not limited to, visual information to users, such as external agents. The output device may include a display on computing devices and virtual reality glasses. For example, the display may be a mobile phone screen or a laptop screen. GUIs and/or text may be presented as an output on the display screen. The computer system may further include an input device to provide a user or another device with mechanisms for entering data and/or otherwise interacting with the computer system. The input device may include, for example, a keyboard, a keypad, a mouse, or a touchscreen. Each of these output devices and input devices may be joined by one or more additional peripherals. For example, the output device may be used to display the results such as bot responses by the executable chatbot.

A network communicator may be provided to connect the computer system to a network and in turn to other devices connected to the network including other clients, servers, data stores, and interfaces, for example. A network communicator may include, for example, a network adapter such as a LAN adapter or a wireless adapter. The computer system may include a data source interface to access the data source. The data source may be an information resource. As an example, a database of exceptions and rules may be provided as the data source. Moreover, knowledge repositories and curated data may be other examples of the data source.

Embodiments of the present disclosure provide systems and methods for categorizing personal information into relevant categories corresponding to the plurality of secondary intelligent communicative agents (304-1, 304-2, . . . , 304-N). The present disclosure ensures robust data categorization, allowing users to organize the information into distinct categories like family, work, and friends, while safeguarding sensitive data by preventing accidental data sharing across inappropriate contexts. The present disclosure enables dynamic decision-making through real-time querying of various AI agents, thereby empowering users to make well-informed choices. This collaborative querying approach fosters effective communication and informed decision-making processes, enhancing user satisfaction and experience. Further, the present disclosure facilitates seamless communication between agents representing different individuals, allowing collaborative decision-making.

The written description describes the subject matter herein to enable any person skilled in the art to make and use the embodiments. The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

We claim:

1. A system for categorizing personal information by integrating one or more intelligent communicative agents, the system comprises:
at least one primary intelligent communicative agent;
a plurality of secondary intelligent communicative agents, wherein each of the plurality of secondary intelligent communicative agents are associated with scope of a predefined field;
a memory unit, wherein the memory unit is configured to store information related to the at least one primary intelligent communicative agent and the plurality of secondary intelligent communicative agents;
one or more processors, wherein one or more processors are configured to:
identify nature of request and relevant fields to be addressed by at least one primary intelligent communicative agent,
determine normalized threshold by at least one primary intelligent communicative agent to ensure further processing,
trigger communicative interaction between at least one primary intelligent communicative agent and the plurality of secondary intelligent communicative agents, and/or between each of the plurality of secondary intelligent communicative agents,
generate a real time information based on the communication between the at least one primary agent and the plurality of secondary intelligent communicative agents;
one or more communication networks, wherein the one or more communication networks are configured to receive as generated real time information from the at least one primary intelligent communicative agent and transmit the real-time information to one or more user devices communicatively coupled to the system; and
a database configured to receive information from the system by means of the one or more communication networks and store the information for future purposes.

2. The system according to claim 1, wherein the at least one primary communicative agent selectively triggers inter-communication between one or more secondary intelligent communicative agents of the plurality of secondary intelligent communicative agents by identifying the required field upon receipt of request.

3. The system according to claim 1, wherein the at least one primary communicative agent delegates task to one or more of the plurality of secondary intelligent communicative agents upon identifying the required field.

4. The system according to claim 1, wherein the one or more processors comprises of an access control device configured to authenticate access to each of the plurality of secondary intelligent communicative agents such that each of the plurality of secondary intelligent communicative agents operate within the predefined field.

5. The system according to claim 1, wherein at least one primary intelligent communicative agent co-ordinates with each of the plurality of secondary intelligent communicative agents by principle of local inter-process communication and wherein inter-communication between the plurality of secondary intelligent communicative agents is performed following a two-way communication protocol implementing neural networks.

6. The system according to claim 1, wherein the one or more processors are configured to:
prompt for feedback on action undertaken by at least one primary intelligent communicative agent,
store the feedback received into a storage unit,
readapt the at least one primary intelligent communicative agent and the plurality of secondary intelligent communicative agents based on the feedback received.

7. The system according to claim 1, wherein the system is configured to allow independent inter-communication between each of the plurality of secondary intelligent communicative agents.

8. The system according to claim 1, wherein the database may include but is not limited to personal data, health data, lifestyle data, any other data, and combinations thereof.

9. The system according to claim 1, wherein the plurality of secondary intelligent communicative agents may include but is not limited to family agent, work agent, friends agent, budget agent, sports agent and a plurality of other agents.

10. The system according to claim 1, wherein the information processed and transmitted by the plurality of other agents may include but is not limited to health, travel, entertainment and like fields.

11. A method for categorizing personal information by integrating one or more intelligent communicative agents, the method comprising:
receiving request by at least one primary intelligent communicative agent;
identifying nature of request and relevant fields to be addressed by at least one primary intelligent communicative agent;
determining normalized threshold by at least one primary intelligent communicative agent to ensure further processing;
triggering communication with one or more of the plurality of secondary intelligent communicative agents based on normalized threshold received by the at least one primary intelligent communicative agent by one or more processors;
delegating specific tasks by at least one primary intelligent communicative agent to the one or more of the plurality of secondary intelligent communicative agents via the one or more processors;
generating real time information by the one or more processors based on the communication between the at least one primary intelligent communicative agent and the plurality of secondary intelligent communicative agents;
transmitting as generated real time information by the at least one primary intelligent communicative agent to one or more communication networks by the one or more processors;
transmitting the generated real-time information to one or more user devices by the one or more communication networks upon receipt;
prompting for feedback by the one or more processors on action undertaken by at least one primary intelligent communicative agent;
storing the feedback received into a storage unit; and
readapting the at least one primary intelligent communicative agent and the plurality of secondary intelligent communicative agents based on the feedback received.

12. The method according to claim 11, wherein the method includes selectively triggering inter-communication between one or more secondary intelligent communicative agents of the plurality of secondary intelligent communicative agents by identifying the required field.

13. The method according to claim 11, wherein the method includes authenticating access to each of the plurality of secondary intelligent communicative agents such that each of the plurality of secondary intelligent communicative agents operate within the predefined field.

14. The method according to claim 11, wherein the method includes performing inter-communication between the plurality of secondary intelligent communicative agents by means of a two-way communication protocol implemented using neural networks.

15. The method according to claim 11, wherein the method includes communication between at least one primary intelligent communicative agent and each of the plurality of secondary intelligent communicative agents by principle of local inter-process communication.

16. The method according to claim 11, wherein the method includes iterative training of the at least one primary intelligent communicative agent and the plurality of secondary intelligent communicative agents followed by adjusting normalized threshold in order to readapt the at least one primary intelligent communicative agent and the plurality of secondary intelligent communicative agents.

17. The method according to claim 11, wherein the method includes monitoring of response time, modifications to suggestions as provided by the at least one primary intelligent communicative agent and the plurality of secondary intelligent communicative agents to provide an implicit feedback.

18. A non-transitory machine-readable medium including data, which when used by a system for categorizing personal information by integrating one or more intelligent communicative agents, causes the system to perform instructions that cause the system to perform operations, comprising:
receiving, by at least one primary intelligent communicative agent, a request from a user for performing a task by the at least one primary intelligent communicative agent;
identifying, by at least one primary intelligent communicative agent, at least one category-specific AI agent from the plurality of secondary intelligent communicative agents based on the request;
extracting, by the at least one primary intelligent communicative agent, relevant information related to the request from each of at least one category-specific AI agent of the plurality of secondary intelligent communicative agents based on the request;
triggering, by the at least one primary intelligent communicative agent, at least one agent from the plurality of secondary intelligent communicative agents based on the request, wherein at least one agent from the plurality of secondary intelligent communicative agents provides information related to the request;
determining, by the at least one primary intelligent communicative agent, a normalized threshold score based on one or more parameters of the plurality of secondary intelligent communicative agents;
generating, by the at least one primary intelligent communicative agent, at least one recommendation from the relevant information based on the normalized score; and
providing, by the at least one primary intelligent communicative agent, at least one recommendation to the user in response to the request.
